(19) United States
(12) Patent Application Publication
(10) Pub. No.: US 2008/0317538 A1
(43) Pub. Date: Dec. 25, 2008

(54) MAKEUP APPLICATION AND REMOVAL APPARATUS AND METHOD

(76) Inventor: Izabella Wojtowicz, Wayne, PA (US)

Correspondence Address: Mr. Walter J. Tencza Jr., Suite 210, 100 Menlo Park, Edison, NJ, 08837, US

(21) Appl. No.: 12/141,689

(22) Filed: Jun. 18, 2008

Related U.S. Application Data
(60) Provisional application No. 60/944,937, filed on Jun. 19, 2007.

(51) Int. Cl. B05C 1/00; A46B 11/00; B43K 27/00; B43K 24/00; A45D 29/00

(52) U.S. Cl. 401/17; 401/16; 401/33; 401/99; 132/200

(57) ABSTRACT

An apparatus is provided including a first device for applying makeup, and a second device for removing makeup. The first device may be attached to the second device. The first device may include a first container having nail polish and a first applicator tip for applying the nail polish. The second device may include a second container having nail polish remover and a second applicator tip for removing nail polish.

### CROSS REFERENCE TO RELATED APPLICATION(S)

The present application claims the priority of U.S. provisional application Ser. No. 60/944,937, filed on Jun. 19, 2007, by inventor Izabella Wojtowicz.

### FIELD OF THE INVENTION

The present invention relates to methods and apparatus concerning makeup application and removal, such as nail polish application and removal.

### BACKGROUND OF THE INVENTION

Many women find painting their own nails to be difficult. There is little control over the brush, especially when working with the less dominant hand. Streaks and smudges are not only unattractive but also time consuming, as they require additional time for making corrections with a cotton swab dipped in polish remover. Professional manicures or pedicures are not always an option to the nail polish user due to costs, availability, and convenience. Nail polish often chips and sometimes polish color needs to be changed in between appointments to coordinate it with a specific outfit.

### SUMMARY OF THE INVENTION

This invention provides an improved method of applying nail polish. An apparatus is a hand-held, pen-like device, which is easy to operate and creates the look of a professional manicure or pedicure at a reduced cost. Build in one embodiment of a triangular shape, this device allows the user to have a comfortable and steady grip, enabling painting nails with greater control, precision and neatness. Moreover, a specially designed and engineered sliding button, on the top of the device, permits the nail polish to be equally dispensed on the bristles and evenly applied onto the nail. There is no other nail polish pen in the market that has these unique and convenient features of sliding button or shape. This apparatus presents also a dual function nail polish pen, as it integrates polish remover. Thus, it allows women not only to paint their nails easily and with decreased untidiness but also to remove unwanted painting mistakes quickly and conveniently without the need for separate tool to make corrections. Therefore, this device provides an improved and sophisticated method of applying nail polish, and unique/futuristic appeal departing from the prevalent variations of nail polish shapes on the market.

In at least one embodiment, an apparatus is provided including a first device for applying makeup, and a second device for removing makeup. The first device may be attached to the second device. The first device may include a first container having nail polish and a first applicator tip for applying the nail polish. The second device may include a second container having nail polish remover and a second applicator tip for applying nail polish remover. The first container may have a portion, which is substantially cylindrically shaped and has a first chamber, which includes nail polish. The second container may have a portion, which is substantially cylindrically shaped and has a second chamber, which includes nail polish remover.

The first applicator tip may be located at a first end of the apparatus, while the second applicator tip may be located at a second end of the apparatus. The first end may be opposite the second end. The apparatus may further include a first cap, which is configured to cover the first applicator tip at the first end of the apparatus, and a second cap, which is configured to cover the second applicator tip at the second end of the apparatus.

The apparatus may further include a projection/retraction device, which can place the second applicator tip in either a projection state or a retraction state. In the projection state the second applicator tip projects outwards from the second container. In the retraction state the second applicator tip does not project outward from the second container. The second applicator tip in the retraction state accumulates nail polish from the second container. The projection/retraction device may include a spring.

At least one embodiment of the present invention includes a method comprising applying makeup using a first device of an apparatus, and removing makeup using a second device of an apparatus. The apparatus may be configured as previously described.

### BRIEF DESCRIPTION OF THE DRAWINGS

FIG. 1 shows a perspective view of a nail polish apparatus in accordance with an embodiment of the present invention, with the nail polish apparatus shown in a first disassembled state;

FIG. 2 shows a perspective view of the nail polish apparatus of FIG. 1, with the nail polish apparatus shown in an assembled state;

FIG. 3A shows a perspective view a portion of the nail polish apparatus of FIG. 1, with the portion of the nail polish apparatus shown in a first operational state;

FIG. 3B shows a perspective view the portion of the nail polish apparatus of FIG. 1, with the portion of the nail polish apparatus shown in a second operational state;

FIG. 3C shows a perspective view the portion of the nail polish apparatus of FIG. 1, with the portion of the nail polish apparatus shown in a third operational state; and

FIG. 4 shows a perspective view of the nail polish apparatus of FIG. 1, with the nail polish apparatus shown in a second disassembled state.

### DETAILED DESCRIPTION OF THE DRAWINGS

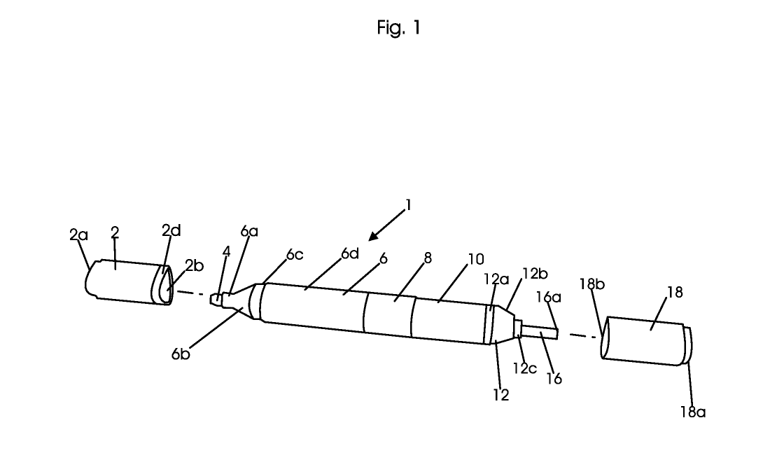

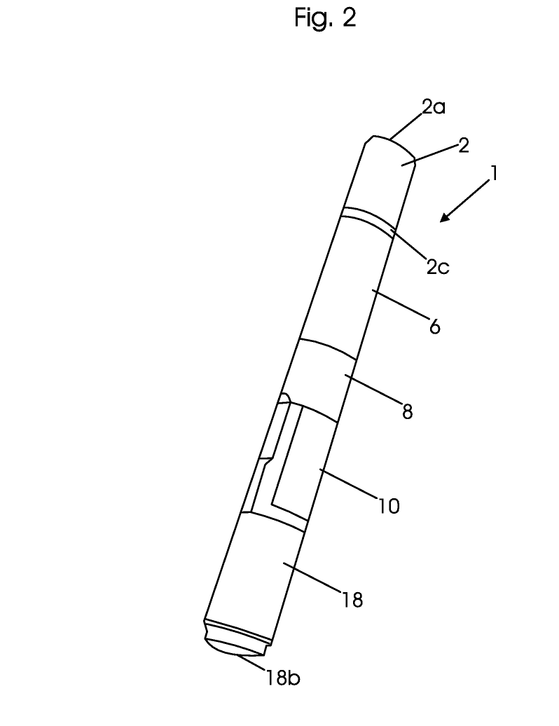

FIG. 1 shows a perspective view of a nail polish apparatus 1 in accordance with an embodiment of the present invention, with the nail polish apparatus 1 shown in a first disassembled state. FIG. 2 shows a perspective view of the nail polish apparatus 1 of FIG. 1, with the nail polish apparatus 1 shown in an assembled state.

The nail polish apparatus 1 includes a cap 2, a tip 4, a remover container 6, a shell of a nail polish container 8, a window 10 or transparent shell 10, a nail polish container 12 (nail polish container 12 may include shell 10, bristle or bristles 16, and a cap 18. Each of the caps 2 and 18 may be substantially cylindrical. The caps 2 and 18 have closed ends 2a and 18a, open ends 2b and 18b, and inner chambers 2c and 18c, respectively. The cap 2 can lock on top of the cap 18 or the cap 18 can lock on top of the cap 2, when one side of the nail polish apparatus 1 is not in use. For example, the closed end 2a of the cap 2 can be inserted into the open-end 18b of the cap 18 in order to snap or attach cap 18 on top of cap 2.

The bristles 16 and the nail polish container 12 may be considered to be part of a first device for applying makeup. The tip 4 and the bristles 16 may be considered to be applicator tips. The tip 4 and the container 6 may be considered to be part of a second device for removing makeup.

The cap 2 has a closed top 2a, a side band 2d, and a bottom opening 2b. The tip 4 may be a fiber tip made for removing nail polish and/or may be a remover tip for removing makeup. The remover container 6 may include portions 6a, 6b, 6c, and 6d. The shell of the nail polish container 8 may be made of clear plastic Polyethylene Terephthalate. The window or transparent shell 10 may be a window, which allows one to see the color of nail polish contained within the shell 10 and/or within the container 12. The nail polish container 12, or a portion of, may be transparent. The bristle or bristles 16 may include a tip 16a. The bristle or bristles 16 may include a portion 16b for connecting to the container 12 so that the bristles or bristles 16 protrude out from end or portion 12c of the container 12. This configuration allows replacement of bristle or bristles 16.

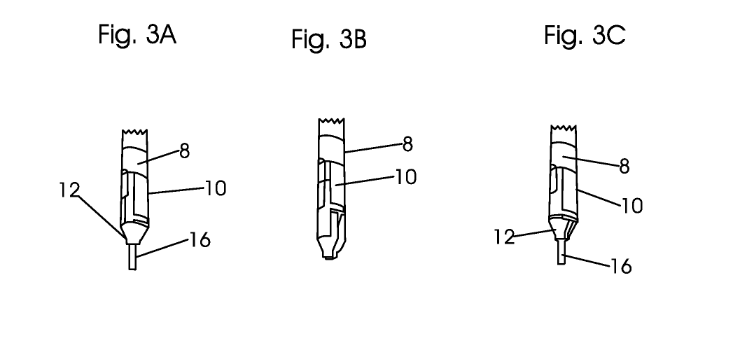

FIG. 3A shows a perspective view of a portion of the nail polish apparatus 1 of FIG. 1, with the portion of the nail polish apparatus 1 shown in a second operational state. FIG. 3A shows shell 8, window 10, nail polish container 12 and bristle 16. In FIG. 3A, the tip 16a of the bristle 16 is in a relaxed state extending outward from the container 12.

FIG. 3B shows a perspective view the portion of the nail polish apparatus 1, with the portion of the nail polish apparatus 1 shown in a second operational state. In FIG. 3B, the container 12 has protruded over bristles 16. Two little holes are placed punctured inside of the tip or portion 12c of the container or compartment 12. The holes inside container 12 allow nail polish to come out from the container 12 onto the bristles 16 when in the operational state of FIG. 3B.

FIG. 3C shows a perspective view the portion of the nail polish apparatus 1, with the portion of the nail polish apparatus 1 shown in a third operational state. In FIG. 3C, the tip 16a is now back in the relaxed state extending outward from the container 12. In FIG. 3C nail polish has been placed on the bristles 16.

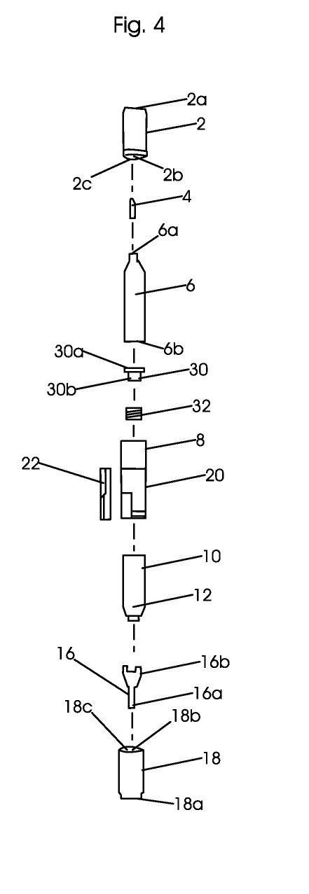

FIG. 4 shows a perspective view of the nail polish apparatus 1 of FIG. 1, with the nail polish apparatus 1 shown in a second disassembled state. FIG. 4 shows sliding button 22 cap 2, tip 4, which may be a fiber tip for a nail polish remover, a compartment or portion 6 for holding the nail polish remover, a compartment or portion 8 that holds a spring 32, which may be circular. The spring 32 helps retract the sliding button 22 back into its original place. The portion 20 may be a plastic compartment that connects the nail polish remover compartment or portion 6 and application compartment or nail polish container 12, and holds the sliding button 22 in place. The container 12 is typically a transparent Polyethylene Terephthalate container that holds nail polish paint. The cap 18 protects the bristles 16 from air exposure. The nail polish apparatus 1 also includes a spring insert 30 and the spring 32. The spring insert 30 has a portion 30a and a portion 30b. The portion 30a may be substantially cylindrically shaped and may fit into an opening 6b of the container 6. The portion 30b may be substantially cylindrically shaped and can be inserted into a bore of the spring 32, so the spring surrounds the portion 30b, while the portion 30a is larger than the bore of the spring 32.

In operation, with the apparatus 1 in the closed state shown in FIG. 2, a user may take off the cap 18 and push sliding button 22, which causes the compartment or container 12 to move on top of the bristles 16 allowing an equal flow of nail polish onto the bristles 16 as shown in FIG. 3B. Nail polish is released from inner holes located on the inside of compartment or portion 22. When the button 22 retracts into its original place as shown in FIG. 3C the holes are tightly secured by the plastic clip portion 16b holding the bristle tips 16a. When the user has finished painting their nails with the tip 16a, they can use the reverse side of the apparatus 1, i.e., use the moist angled fiber tip 4 in order to remove any unwanted painting mistakes.

The apparatus 1 provides consumers with an easier, more convenient means of applying nail polish. The apparatus 1, as shown in FIG. 2, may be a hand-held, plastic, pen-shaped unit. The bristle tip 16a is not made of plastic. Tip 4 is made out of a sponge like fiber that stays moist because compartment 6 holds the nail polish remover.

The apparatus 1 contains multiple segments; one segment with the colored polish, i.e. nail polish container 10 and/or 12; and another segment or portion, such as remover container 6 with either the polish remover or white polish used for French manicures, or additional polish colors. One end of the apparatus 1, features soft bristles, such as bristles 16 shown in FIG. 1, that are covered with cap 18. The opposite end of the apparatus 1 is designed with interchangeable tips, such as tip 4, including a cone-shaped tip used to remove smudges or smears, a nail file, additional polish bristles or a pen-like structure used to apply nail designs.

A sliding shaped grip button 22 in FIG. 4 is depressed in order to dispense the desired amount of liquid into bristle or bristles 16. The bristles 16 include bristle tip or bristle 16a and clip 16b. The bristle tip 16a are attached to clip 16b, and the clip 16b with the bristle tips 16a can be clicked out of its compartment in 12, and replaced when necessary. This enables a user to dispose of the bristles 16, if the bristle tips 16a are hardened after many applications.

The apparatus 1 can easily be slipped into a purse, briefcase or bag, providing a means of applying polish anytime. In one embodiment, smears are quickly fixed with the integrated remover and/or tip 4. In order to accommodate user needs and preferences, the apparatus 1 may be offered in a wide range of colors. Due to the increased precision and convenience provided by the product's design, the apparatus 1 may be an indispensable nail care solution for any woman.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first device for applying makeup; and
a second device for removing makeup;
wherein the first device is attached to the second device.

2. The apparatus of claim 1 wherein
the first device includes a first container having nail polish and a first applicator tip for applying the nail polish; and
the second device includes a second container having nail polish remover and a second applicator tip for removing nail polish.

3. The apparatus of claim 2 wherein
the first container has a portion which is substantially cylindrically shaped and has a first chamber which includes nail polish; and
the second container has a portion which is substantially cylindrically shaped and has a second chamber which includes nail polish remover.

4. The apparatus of claim 2 wherein
the first applicator tip is at a first end of the apparatus;
the second applicator tip is at a second end of the apparatus;
and wherein the first end is opposite the second end.

5. The apparatus of claim 4 further comprising
a first cap, which is configured to cover the first applicator tip at the first end of the apparatus; and
a second cap which is configured to cover the second applicator tip at the second end of the apparatus.

6. The apparatus of claim 4 further comprising
a projection/retraction device which can place the second applicator tip in either a projection state or a retraction state;
wherein in the projection state the second applicator tip projects outwards from the second container; and
and wherein in the retraction state the second applicator tip does not project outward from the second container.

7. The apparatus of claim 6 wherein
the second applicator tip in the retraction state accumulates nail polish remover from the second container.

8. The apparatus of claim 6 wherein
the projection/retraction device includes a spring.

9. A method comprising:
applying makeup using a first device of an apparatus; and
removing makeup using a second device of an apparatus; and
wherein the first device and the second device are attached together.

10. The method of claim 9 wherein
the first device includes a first container having nail polish and a first applicator tip for applying the nail polish; and
the second device includes a second container having nail polish remover and a second applicator tip for applying nail polish remover;
wherein applying makeup includes applying nail polish;
and wherein removing makeup includes removing nail polish.

11. The method of claim 10 wherein
the first container has a portion which is substantially cylindrically shaped and has a first chamber which includes nail polish; and
the second container has a portion which is substantially cylindrically shaped and has a second chamber which includes nail polish remover.

12. The method of claim 10 wherein
the first applicator tip is at a first end of the apparatus;
the second applicator tip is at a second end of the apparatus;
and wherein the first end is opposite the second end.

13. The method of claim 12 wherein
the apparatus further includes a first cap, which is configured to cover the first applicator tip at the first end of the apparatus; and
the apparatus further includes a second cap which is configured to cover the second applicator tip at the second end of the apparatus.

14. The method of claim 12 wherein
the apparatus further includes a projection/retraction device which can place the first applicator tip in either a projection state or a retraction state;
wherein in the projection state the first applicator tip projects outwards from the first container; and
and wherein in the retraction state the first applicator tip does not project outward from the first container.

15. The method of claim 14 wherein
the second applicator tip distributes nail polish remover from the second container when pressed against an individual's fingernail.

16. The method of claim 15 wherein
the projection/retraction device includes a spring.
